(19) United States
(12) Patent Application Publication
(10) Pub. No.: US 2011/0133663 A1
(43) Pub. Date: Jun. 9, 2011

(54) HIGH-PRESSURE DISCHARGE LAMP

(75) Inventor: Klaus Stockwald, Germering (DE)

(73) Assignee: OSRAM GESELLSCHAFT MIT BESCHRAENKTER HAFTUNG, Muenchen (DE)

(21) Appl. No.: 13/058,017

(22) PCT Filed: Jul. 20, 2009
(86) PCT No.: PCT/EP2009/059304

§ 371 Date: Feb. 8, 2011

(30) Foreign Application Priority Data
Aug. 14, 2008 (DE) 10 2008 037 656.6

(51) Int. Cl. H01J 11/00; H01J 61/12; H01J 61/18; H05B 41/24

(52) U.S. Cl. 315/246; 313/567; 313/568; 313/638

(57) ABSTRACT

A high-pressure discharge lamp, which has no electrodes and is excited by means of high-frequency electromagnetic waves, may include an ceramic elongated discharge vessel, which has an axis, where the discharge vessel has a filling that forms a plasma, when radio frequency power (RF) is coupled into the filling from the base body, where the filling comprises a gas and at least one metal halide, where a circuit for operation of the lamp is coordinated, which provides RF power, so that the coupled-in RF power vaporizes the metal halide, which leads to light emission, wherein the discharge vessel is specially designed for operation with acoustic modulation control of the plasma flow, wherein the discharge vessel is divided into a central part with at least approximately constant internal diameter and two ends, whose internal diameter reduces towards the end.

### TECHNICAL AREA

The invention is based on a high-pressure discharge lamp according to the preamble of claim 1.

### PRIOR ART

Modulated microwave lamps are known from WO 2008/048978.

Similar resonant operated lamps are known from U.S. Pat. No. 5,508,592 and U.S. Pat. No. 6,737,815. The electrodeless discharge lamp vessels are here always cylindrical with hemispherically rounded corners.

### REPRESENTATION OF THE INVENTION

The object of the present invention is to provide a microwave-excited high-pressure discharge lamp having low color fluctuation and good maintenance properties.

This object is achieved by the characterizing features of claim 1.

Particularly advantageous embodiments may be found in the dependent claims.

According to the invention, high efficiency high-pressure discharge lamps without electrodes and excited by RF or microwaves are proposed, whose convection is acoustically controlled and which are thus plasma-stabilized. They are characterized by low color fluctuation and good maintenance properties.

Modern ceramic metal halide lamps with electrodes have the problem of relatively high losses at the electrodes. Electrode losses via voltage drops and thermal conduction to the lamp connections or feed lines amount to 10 to 20% in terms of the power balance, and losses typically average 15%.

Suitable fillings for the discharge vessel are well-known metal halide fillings, and the discharge vessel in particular contains a filling with metal halides, which is selected from the group of iodides of Na, Li, Tl, Ca, rare earth metals (SE) either alone or in combination. The system is in particular suitable for the following fill system: NaJ, T1J, CaJ2 together with SEJ3, where SE is at least one of the elements Tm, Ce, Pr, Nd.

Particularly with the use of metal halide fillings containing Na/Li and/or Ce/Nd/Pr, a separation, to a greater or lesser degree, of the fused material in the entry area of the electrodes takes place, which can lead to a change in the color quality and the light yield. During operation of the lamps even with low current load, electrodes, which are typically made of tungsten, are unavoidably subject to erosion of the tungsten, which results in electrode burn back and blackening of the burner wall. The end of the useful life of such lamps is caused by electrode burn back and filling migration.

Until now, ceramic metal halide discharge lamps have been operated using electrodes. Commercially speaking, electrodeless operation of such lamps is limited to low-power quartz vessels for projection applications with low light yield or to high outputs of typically at least 250 W with forced cooling. In operation of this type no permanent acoustic influence is actually employed on convection for plasma stabilization. Universal operation in any orientation is only possible in the case of ceramic vessels with low performance if a plasma stabilization generates low thermoelectric forces in the burner.

The following explanation will aid better understanding of the invention:

Ceramic discharge lamp vessels with metal halide filling are advantageously used for operation with acoustic resonances. In order to ensure high efficiency, which can be in the range between 120 and 175 lm/W, it has been shown that the thermal conditions must be selectively improved. To this end an acoustically induced convection for different power ratings must be selectively actuated, which is scaled to the surface of the discharge vessel according to certain rules. New thermal conditions can thereby be enforced, which establish efficiency typically at levels of 140 to 150 lm/W stable over time.

The aim is to achieve multicell-convection that is stable over time. This can then be maintained across a power range of ratings. It is of decisive importance here to define areas of specific surfaces and to observe guidelines for this. A suitable characteristic value for this purpose is the power density.

Through the describing of scaling laws for the relationships of surfaces with reference to the power rating used, ceramic discharge lamp vessels for different performance classes and light flux classes can be configured.

The invention selectively regulates the convection flow in the discharge plasma of the filler gas, which is selectively influenced by means of acoustic modes. This flow of the filler gas would lead to an additional heat flow towards the end of the discharge volume. This would call for a heating of this end and of the cold-spot. To stem this heating an effective end cooling must be established, so that the cold-spot and the end of the discharge vessel are not heated too strongly.

In order to be able to operate a metal halide lamp in the longitudinal acoustic mode, the geometry of the discharge vessel should have a so-called aspect ratio AV of at least 2. It preferably lies in the range 3.5 to 6, in particular the AV=4.5 to 5.5, with an aspect ratio AV of 4.6 to 4.8 being particularly suitable. The aspect ratio is the relationship between the internal length and the internal diameter of the discharge vessel. The discharge vessel has a longitudinal axis and is essentially cylindrical. It can also readily be bulged in the middle. An operating method for such lamps is for example disclosed in U.S. Pat. No. 6,400,100.

A discharge vessel cylindrical in relation to the internal volume is preferably employed. It has an external surface area and external faces or at least bevels. The external surface area plus the external bevels and faces define an overall external surface OSUM. If the power rating P is set in relation to this entire external surface OSUM, it is evident that for a high efficiency the thus defined specific power rating PS=P/OSUM must attain a value of 17 to 25 W/cm², while at the same time the inner wall loading on the inner surface must be kept at a high level. It should reach at least 28 W/cm².

To understand the invention it is necessary to imagine the discharge vessel being divided into three sections across the longitudinal axis. The boundary is here the change in curvature of the discharge vessel. A centrally-located area with little change in curvature, preferably with the change in curvature zero, that is the internal diameter is constant or changes only a little (change less than 15% over the internal length), defines a hot plasma section, into which the discharge plasma extends. In operation it becomes relatively hot. The wall loading in the area of this plasma section should preferably be in the range 28 to 45 W/cm². This external surface of the plasma section is marked OH.

The surface of the ends that lie behind, including the bevels or faces, which effect the cooling, is identified with OK. As the discharge vessel has two ends, the surface of both ends must be referred to. As a rule, both ends are symmetrical, so that each cooling surface has half of OK.

Cooling is then particularly effective if the section of the curve to which OH is assigned attains the high wall loading W of at least 28 W/cm² during operation, while the whole surface OSUM, that is the sum of OH and OK has the markedly lower specific power rating von 17 to 25 W/cm². In other words the surface OK in the area of the ends must be sufficiently large. The relationship VH between OK and OH is preferably 0.75 to 1.00. It particularly preferably lies in the range VH=0.85 to 0.90. VH can be modified by means of technical refinements such as coatings in the area of OK.

Advantages of the invention are possibilities for the realization of long-life high efficiency ceramic high-pressure lamp systems of low and medium power, for example with efficient microwave excitation methods. Particularly compact lamp systems can thus be realized.

Low-Hg and Hg-free fillings can now be used without the impairment of metallic electrodes and metallic entry areas. The acoustic configuration of the convection now employs an elongated discharge vessel with conically tapered ends. Flanges can advantageously be present on the discharge vessel. This arrangement permits a high-load burner operation in air or in the vacuum outer bulb at the same time as low thermoelectric forces, as the discharge plasma is retained in the interior of the burner by the convection set up, and the contact with the ceramic wall can largely be stabilized and minimized.

The lamp is in particular operated on a modulatable semiconductor high frequency generator, preferably a microwave (MW) generator (amplifier circuit in AB/C, D, E or F-class operation or for a class that can be switched to different operating states) with a matching network and coupling applicator in the frequency range 50 MHz to 5 GHz. Preferable is a range typically between 200 MHz and 3 GHz, particularly preferably from 500 MHz, such that an arc stabilization on the burner axis occurs. This takes place through the use of an acoustically induced arc straightening effect. To this end the second azimuthal resonance frequency is periodically excited. Particularly preferably a blending of the plasma by the setting-up of an acoustically induced multicell structure through the application of a standing wave field of a straight-line longitudinal resonance frequency is achieved.

The modulation of the carrier frequency (typ. 200 MHz to 3 GHz) takes place via amplitude modulation, such that the second azimuthal resonance frequency is periodically overscanned in a periodicity of 10 ms to 1 ms, specifically from f_{center}−□f to f−_{center}+□f; with 0.5 kHz<=□f<=15 kHz, where 5 kHz is typical.

As a further option this modulation can be overlaid by a further modulation (for example by means of the summation of the modulation frequencies), which generates an excitation line in the power spectrum, which in an imprinting phase after the lamp start with a rate of approx. 50 Hz/sec to 1 kHz/sec runs from a start frequency fₛₜₐᵣₜ which at approx. 1.25-1.3*flong hor (position of the long. resonance in horizontal operation) lies above the longitudinal resonance frequency (preferably the second) in the horizontal position to a stop-frequency in the position below the longitudinal resonance frequency (typ. 0.05 kHz to 2.5 kHz distance) measured in the horizontal position, and corresponds to a proportion of the line power of 3-35% of the total electrical power. Here an acoustically induced multicell convection structure is set up in a stable manner and stabilized over a long period. The result is two or more plasma constrictions arranged symmetrically in relation to the center of the lamp at the positions of the pressure nodes of the standing wave field of the then optimally excited longitudinal acoustic resonance.

Depending on the proportion of power of the line power for excitation of the longitudinal resonance, the line power can be subjected to a further modulation or sweep movement during long-term operation.

Used as filling components are one or more of the group

T1X, ZnX2, Al2O3, InX, InX3, HfX4, SnX2, MnX2, MgX2, ZrX4, TaX5, HgX2, CsX, NaX, DyX2, GaX3, CeX3, NdX3, PrX3, TmX3, ErX3, HoX3, DyX3, GdX3, TbX3, CaX2, ReX3, WX3, WOX, ReOX, S, Se, Te, Ge, Ga with X=I, Br, Cl, F.

The use of elementary metals and mixtures thereof is likewise possible.

Suitable gases are all the inert gases Ar, Ne, Kr, Xe and N2, CO2, CO, H2, D2, and mixtures thereof.

The pressure range can be 0.1 mbar (cold) to 300 bar (hot). During operation the pressure is preferably 0.5 to 30 bar.

The vessel can comprise ceramic (PCA, Y2O3, AlON, AlN, Zr2O3) or glass ceramic material such as rigid high-temperature solder (binary or ternary eutectic mixtures of metal oxides (e.g. Y2O3, Al2O3, Ce2o3, SiO2, Dy2O3, CaO, etc.) or a (quartz) glass vessel or hybrid material systems.

The internal diameter ID of the lamps can preferably be 0.1 mm to 15 mm, preferably at most 10 mm. The internal length IL can preferably be 0.35 to 90 mm, preferably up to 50 mm.

The wall thickness is typically in the range from about 0.1 mm to 3 mm.

### BRIEF DESCRIPTION OF THE DRAWINGS

The invention is to be explained below on the basis of a number of exemplary embodiments. Where:

FIG. 1 shows a high-pressure discharge lamp with discharge vessel;

FIG. 2 shows different exemplary embodiments of a suitable discharge lamp vessel;

FIG. 3 shows different further embodiments of a suitable discharge lamp vessel;

FIG. 4 shows a system of the high-pressure discharge lamp in detail;

FIG. 5 shows a diagram setting out the aspect ratio against different resonance frequencies at a power of 50 W;

FIG. 6 shows a diagram setting out the aspect ratio against different resonance frequencies at a power of 100 W;

FIG. 7 shows a complete system with high-pressure discharge lamp;

### PREFERRED EMBODIMENT OF THE INVENTION

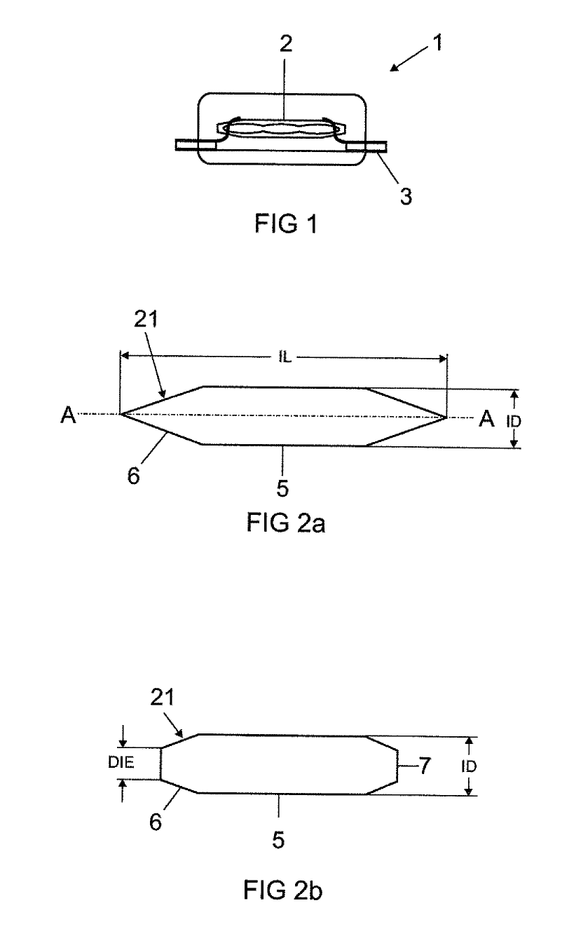

FIG. 1 shows a schematic diagram of an electrodeless discharge lamp 1. It is by nature a ceramic lamp. The discharge vessel 2, made of Al2O3 ceramic, has a specified internal diameter ID, for example 2 mm, and a specified internal length IL, for example 10 mm. The filling contains, for example, NaJ, NaBr, InBr, InJ, CeJ3, CeBr3, Xe, HgJ2 and Hg.

The lamp is operated on a system with stripline coupler 3 with phase shifter/lambda/2-detour line (balun) on an MW amplifier. The MW-frequency is 900 MHz. The lamp power is set at 25 W. The modulation frequency for the sweep is 110 to 125 kHz and the AM-frequency amounts to 45 Khz. The modulation strength of the line frequency is 19%.

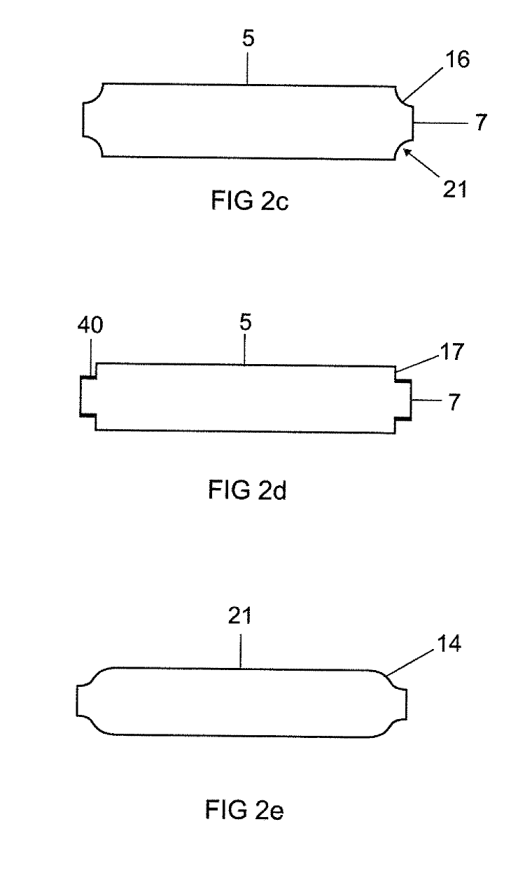

FIG. 2 shows different particularly suitable elongated discharge lamp vessels with narrowed ends and longitudinal axis A. Here the aspect ratio AV, that is the relationship IL/ID, is at least 2, preferably at least AV=3.5. An upper limit is preferably provided by AV=8. The narrowing at the ends 6 extends over a typical length of ⅛ to ⅕ IL.

In the simplest embodiment of FIG. 2a the discharge vessel 21 is equipped with a cylindrical central part 5. The two end parts 6 taper in a conical manner, so that the greatest internal length IL is reached in the axis A.

Instead of a conical narrowing the discharge vessel can according to FIG. 2b also narrow in a blunt manner, so that it has an end surface 7 in the vicinity of the axis and across said axis, which however has a reduced internal diameter DIE. This reduced internal diameter is typically up to 65% of the internal diameter ID of the central part 5.

The reduction of the internal diameter can also be achieved by means of a suitable concave curve 16, see FIG. 2c, or also in the manner of a step 17, see FIG. 2d. A contoured curve 14 with a reversal point is also suitable for reduction of the diameter, see FIG. 2e.

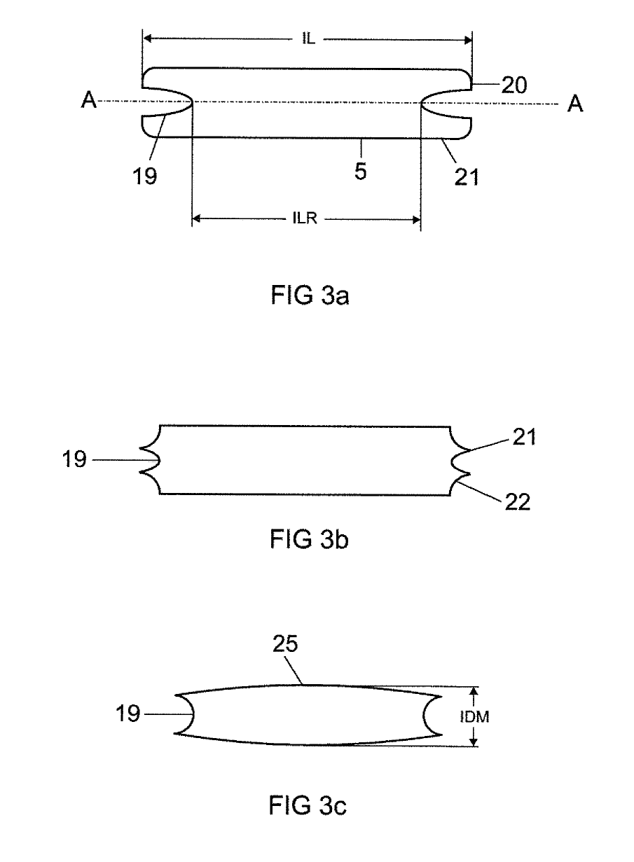

In a second basic embodiment according to FIG. 3 the reduction in the diameter of the discharge vessel is achieved or supported by means of at least one, in particular also two, flanges or bulges. It is thereby brought about that the greatest internal length IL is reached outside the axis A. In axis A, on the other hand, a reduced internal length ILR is obtained. Here too, the entire end surface standing across the axis A is either close to 0% in the case of sharply tapering bulges (FIG. 3b) or it lies in the range 30 to 65% (FIG. 3a).

FIG. 3a shows an exemplary embodiment, in which a central flange 19 is provided at the end of the discharge vessel. Outside the axis A near-flat faces 20 are provided. In the exemplary embodiment in FIG. 3b a flange 19 is provided, where rather than a straight face, a curved narrowing 22 effects the reduction of the internal diameter ID. The discharge vessel then has two frontal tips 21, which point outwards.

In a particular embodiment according to FIG. 3c the central part 25 is not a straight pipe with a constant diameter, but has a slight concave curve, with a maximum IDM in the centre. The difference in the internal diameter at the ends should, however, not amount to more than 10% of the maximum value IDM. In this exemplary embodiment there is no face.

An aspect ratio AV of 3 to 6 is generally particularly suitable, and is very advantageously AV=4.5 to 5.

The end structure with reduced internal diameter helps to stabilize the convection cell flow. The axial length of the end area with reduced diameter should here be as short as possible. It should preferably be a maximum of 30% of the maximum internal length IL. It is then of significant effect in setting up a temperature gradient at the end.

Effective support is also provided by a transparent coating 40 in the visual spectral range, see FIG. 2d, with increased emissivity, which amounts to at least ∈=0.55. The average value in the range 1 to 3 μm is referred to here. This range is commonly referred to as NIR (near-IR). This coating should be applied at least to a part of the cooling end area.

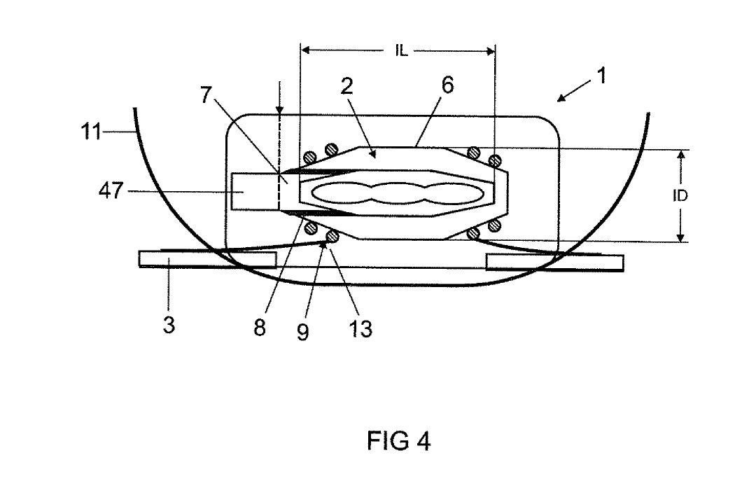

FIG. 4 shows the basic realization of a high-pressure discharge lamp system 1. At the heart of this is the ceramic discharge vessel 2, serving as an acoustic resonator, which is here conical with blunt ends. The practical embodiment is such that the discharge vessel is formed in one piece as a sheath-like tube 6 with a conical end. The sheath has a constant internal diameter ID. The filling is introduced through the second initially open end. The second end is subsequently sealed with a matching plug 7, which is shaped in such a way that it corresponds to the first end in its conical form. The external diameter of the plug is here matched to the diameter ID of the open end such that it can be sealed by means of molten glass solder 8.

The plug has a handling part 47, which subsequently, after insertion and sealing have been completed, can be cut off or modified in shape, for example by means of laser cutting or mechanical grinding, see arrow.

A spiral-winding applicator 9 is applied around the conical end on both sides. It is connected in each case to a stripline 3. The connection is indicated by 13. The system is completed by a dielectric light reflector 11, which has a concave curve and holds the lamp in its center.

This system avoids the high end losses that accompany the use of capillaries and electrode construction. These are in the order of magnitude of 10 to 15% of the input power.

The inventive new forms of vessel create an acoustic multicell excitation of gas convection in the discharge plasma. Here, it is helpful to observe the following conditions, either individually or in combination:

The relationship between the total lamp wattage P (in W) and the total external surface OS should lie in the range 15 to 30, preferably 17 to 25 W/cm². Particularly suitable is a value of P/OS=18 to 22, in particular 19.5 to 21 W/cm².

The relationship between the total lamp wattage P (in W) and the external surface OSZ of the central part (without ends with reduced diameter) should be in the range 25 to 65, preferably 28 to 45 W/cm². Particularly suitable is a value of P/OSZ=30 to 40, preferably 34 to 38 W/cm².

The ratio of the external surfaces between the ends including any face, with both ends being taken together, and the external surface of the central part should be in the range 75 to 125%. A value of 85 to 90% is preferred.

The overall wall loading of the inner surface should preferably be in the range 30 to 45, preferably up to 42 W/cm². Particularly preferable is a value of 36 to 41 W/cm².

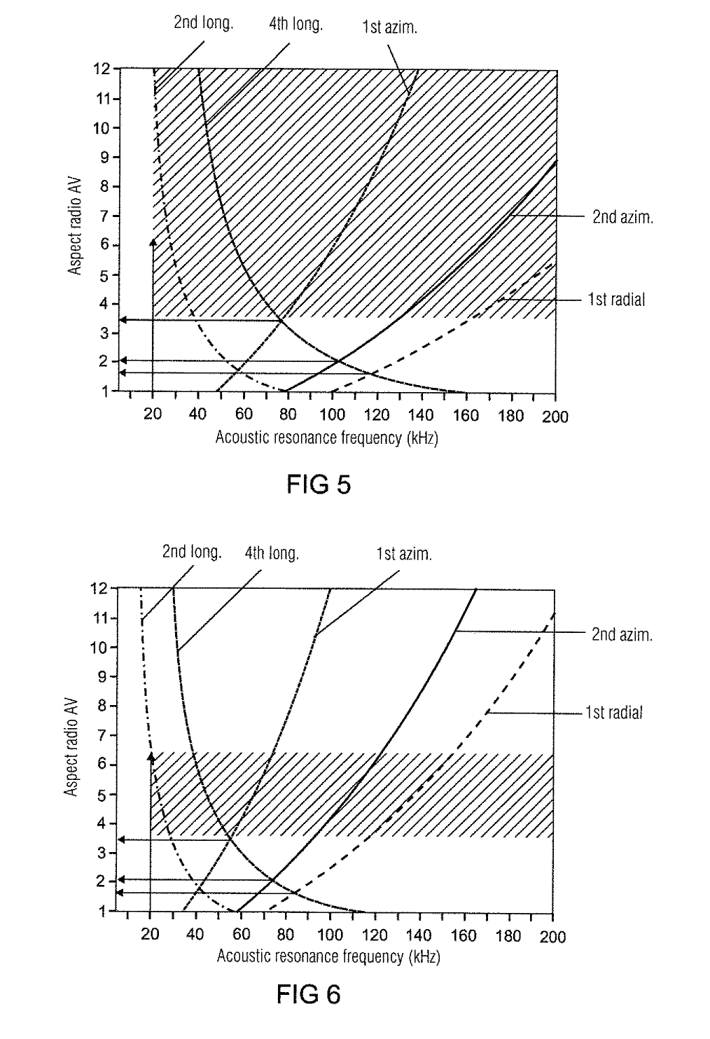

FIGS. 5 and 6 show the selection of the aspect ratio AV for a lamp wattage von 50 W (FIG. 5) and 100 W (FIG. 6). The aspect ratio AV is plotted against the position of the different acoustic resonance frequencies (in kHz). The second and fourth longitudinal resonance frequency are registered, as well as the first and second azimuthal and the first radial resonance frequency.

It is evident that the first azimuthal resonance is unsuitable. It is more destructive than constructive in nature. It exhibits such strong arc distortion that its excitation can result in extinguishing of the arc.

In addition a sufficient distance to the second and fourth longitudinal resonance is necessary. The distance should be at least 5 kHz.

At an aspect ratio of at least 2, or better of at least 3.5, adequate selectability of usable acoustic resonances is attained, including in the case of different wall loading and different power levels.

When choosing a single design to be equally applicable to a wider range of power levels, the aspect ratio selected should if possible be in a range AV=4 to 6. The upper limit is in particular established when the second longitudinal resonance frequency reaches the threshold of audibility of around 19 kHz, see arrow in FIGS. 5 and 6.

A concrete lower limit for the axial length of an end part is 10% of the length of the central part. At the ends of the discharge vessel preferred embodiments of the discharge vessel either have a straight face, or the face is even turned inwards. In this way the convection cells forming there can be additionally stabilized.

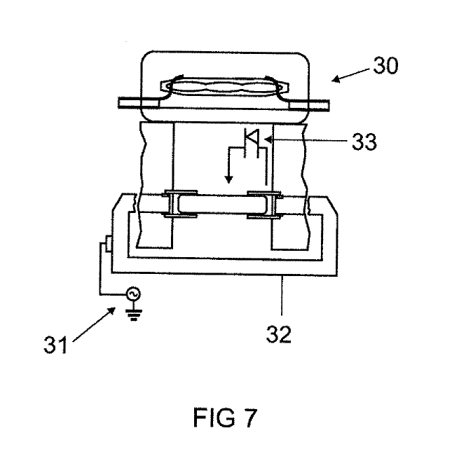

FIG. 7 shows a high-pressure discharge lamp with a discharge vessel 30 and a voltage source 31, plus an EVG 32, which contains an auxiliary ignition circuit 33.

RF 50 MHz to 3 GHz is used as the carrier frequency in operation, where in particular the second azimuthal resonance frequency is periodically excited by amplitude modulation (AM).

A straight-line longitudinal resonance frequency is preferably applied to this frequency as further modulation, preferably the second or fourth longitudinal resonance frequency.

Particularly preferably the modulation of the carrier frequency takes place with a periodicity of 10 ms to 1 ms.

1. A high-pressure discharge lamp, which has no electrodes and is excited by means of high-frequency electromagnetic waves, comprising:
an ceramic elongated discharge vessel, which has an axis,
where the discharge vessel has a filling that forms a plasma, when radio frequency power (RF) is coupled into the filling from the base body,
where the filling comprises a gas and at least one metal halide, where a circuit for operation of the lamp is coordinated, which provides RF power, so that the coupled-in RF power vaporizes the metal halide, which leads to light emission,
wherein the discharge vessel is specially designed for operation with acoustic modulation control of the plasma flow,
wherein the discharge vessel is divided into a central part with at least approximately constant internal diameter and two ends, whose internal diameter reduces towards the end.

2. The high-pressure discharge lamp as claimed in claim 1,
wherein a base body is arranged in the immediate vicinity of the discharge vessel,
wherein the lamp base body comprises a dielectric material.

3. The high-pressure discharge lamp as claimed in claim 1,
wherein the aspect ratio of internal length to internal diameter in the middle of the discharge vessel is at least 2.

4. The high-pressure discharge lamp as claimed in claim 1,
wherein the ratio between the total lamp wattage P (in W) and the total external surface lies in the range 15 to 30 W/cm².

5. The high-pressure discharge lamp as claimed in claim 1,
wherein the ratio between the total lamp wattage P (in W) and the external surface of the central part, without ends with reduced diameter, lies in the range 28 to 45 W/cm².

6. The high-pressure discharge lamp as claimed in claim 1,
wherein the ratio of the external surfaces between the ends, taking both ends together and including any face, and the central part lies in the range 75 to 125%.

7. The high-pressure discharge lamp as claimed in claim 1,
wherein the overall wall loading of the inner surface lies in the range 30 to 45 W/cm².

8. The high-pressure discharge lamp as claimed in claim 1,
wherein the fill pressure of the lamp atmosphere during operation is 0.5 to 30 bar.

9. The high-pressure discharge lamp as claimed in claim 1,
wherein the filling of the discharge vessel contains metal halides from the group Na, Li and/or from the group Tm, Nd, Pr, Ce.

10. The high-pressure discharge lamp as claimed in claim 1,
wherein during operation RF 50 MHz to 3 GHz is used as the carrier frequency, where the second azimuthal resonance frequency is periodically excited by means of amplitude modulation.

11. The high-pressure discharge lamp as claimed in claim 10,
wherein a straight-line longitudinal resonance frequency is applied to this frequency as further modulation.

12. The high-pressure discharge lamp as claimed in claim 11,
wherein the modulation of the carrier frequency takes place with a periodicity of 10 ms to 1 ms.

13. The high-pressure discharge lamp as claimed in claim 3,
wherein the aspect ratio of internal length to internal diameter in the middle of the discharge vessel is at least 3.5.

14. The high-pressure discharge lamp as claimed in claim 11,
wherein a straight-line longitudinal resonance frequency is applied to this frequency as further modulation, namely the second or fourth.
